(19) United States
(12) Patent Application Publication
(10) Pub. No.: US 2010/0050069 A1
(43) Pub. Date: Feb. 25, 2010

(54) SYSTEM AND METHOD FOR CUSTOMIZING DOCUMENTATION WITH CONSTRAINT-CONTROLLED CUSTOM VALUES

(75) Inventors: Andreas Arning, Tuebingen (DE); Peter Bendel, Holzgerligen (DE)

Correspondence Address: SCHMEISER, OLSEN & WATTS, 22 CENTURY HILL DRIVE, SUITE 302, LATHAM, NY, 12110, US

(73) Assignee: INTERNATIONAL BUSINESS MACHINES CORPORATION, Armonk, NY (US)

(21) Appl. No.: 12/196,546

(22) Filed: Aug. 22, 2008

(51) Int. Cl. G06F 17/00

(52) U.S. Cl. 715/234

(57) ABSTRACT

A system and associated method for customizing a documentation. A documentation template has elements and each element can hold a custom value. At least one element is associated with at least one constraint that governs the validity of the custom value for the element. The documentation template is presented and custom values for elements in the documentation template are obtained. The custom value for the element can be interactively provided by a user or automatically determined by system context of the user. Then validity of obtained custom values is checked against constraints associated with each element. Constraints may be classified in determining the impact of violated constraints in generating a customized document. Elements are substituted by valid corresponding custom values, and the customized documentation for the user is generated and stored as a result.

### FIELD OF THE INVENTION

The present invention discloses a system and associated method for improving readability and efficiency of documentation that contains a usage scenario.

### BACKGROUND OF THE INVENTION

Conventional documentation for a complex product often instructs users how to use the product with usage scenarios featuring objects and relations. However, a user of such conventional documentation may have difficulties in familiarizing objects and relations provided in the documentation that are foreign to system environment of the user. System environment descriptions in usage scenarios of conventional documentation that are not familiar to the user force the user to learn and even to remember such unfamiliar objects and relations only to acquire necessary skills for using the product. Consequently, conventional documentation is not conducive to efficient learning because of additional materials to be learned that are unfamiliar to the user and inapplicable to the system environment of the user.

Thus, there is a need for a system and associated method that overcomes at least one of the preceding disadvantages of current methods and systems for providing documentation for complex products.

### SUMMARY OF THE INVENTION

The present invention provides a method for customizing a documentation, the method comprising:

presenting a documentation template comprising at least one element, wherein each element of said at least one element can hold a respective value, wherein at least one element of said at least one element is associated with at least one constraint that governs the respective value of each element;

obtaining the respective value of each element, wherein said respective value is customized for a user of the documentation to provide a preferred context of the documentation to the user;

determining that the respective value of each element satisfies all constraints of said at least one constraint that is associated with said at least one element; and

generating a customized documentation by instantiating said at least one element in the documentation template with said respective value for each element of said at least one element.

The present invention provides a computer program product, comprising a computer usable storage medium having a computer readable program code embodied therein, said computer readable program code containing instructions that when executed by a processor of a computer system implement a method for customizing a documentation, the method comprising:

presenting a documentation template comprising at least one element, wherein each element of said at least one element can hold a respective value, wherein at least one element of said at least one element is associated with at least one constraint that governs the respective value of each element;

obtaining the respective value of each element, wherein said respective value is customized for a user of the documentation to provide a preferred context of the documentation to the user;

determining that the respective value of each element satisfies all constraints of said at least one constraint that is associated with at least one element; and

generating a customized documentation by instantiating said at least one element in the documentation template with said respective value for each element of said at least one element.

The present invention provides a computer system comprising a processor and a computer readable memory unit coupled to the processor, said memory unit containing instructions that when executed by the processor implement a method for customizing a documentation, the method comprising:

presenting a documentation template comprising at least one element, wherein each element of said at least one element can hold a respective value, wherein at least one element of said at least one element is associated with at least one constraint that governs the respective value of each element;

obtaining the respective value of each element, wherein said respective value is customized for a user of the documentation to provide a preferred context of the documentation to the user;

determining that the respective value of each element satisfies all constraints of said at least one constraint that is associated with at least one element; and

generating a customized documentation by instantiating said at least one element in the documentation template with said respective value for each element of said at least one element,

wherein said documentation template and said at least one constraint are written in Extensible Markup Language (XML), and wherein said at least one element can be cross-referenced among elements.

The present invention provides a method and system that overcomes at least one of the current disadvantages of conventional method and system for customizing a documentation with constraint-controlled custom values.

### BRIEF DESCRIPTION OF THE DRAWINGS

FIG. 1 illustrates a system for customizing a documentation for a software product, in accordance with embodiments of the present invention.

FIG. 1A illustrates examples of the customized documentation, in accordance with the embodiments of the present invention.

FIG. 2 is a flowchart depicting a method for customizing a documentation with at least one constraint-controlled custom value, in accordance with the embodiments of the present invention.

FIG. 3 illustrates an example of a documentation template, in accordance with the embodiments of the present invention.

FIG. 4 illustrates an example of a set of constraint definitions provided for the documentation template of FIG. 3, in accordance with the embodiments of the present invention.

FIG. 5 illustrates a computer system used for customizing a documentation with constraint-controlled custom values, in accordance with embodiments of the present invention.

### DETAILED DESCRIPTION OF THE INVENTION

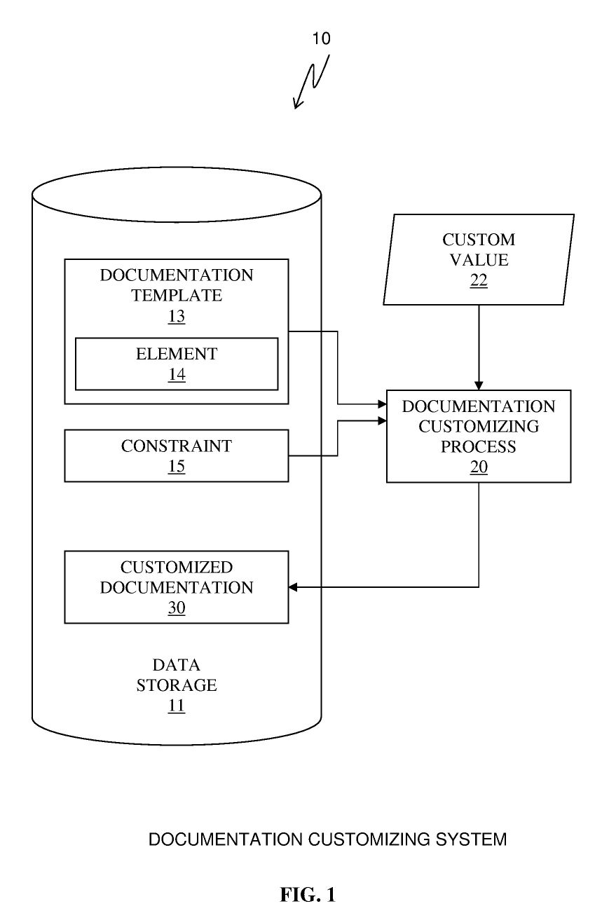

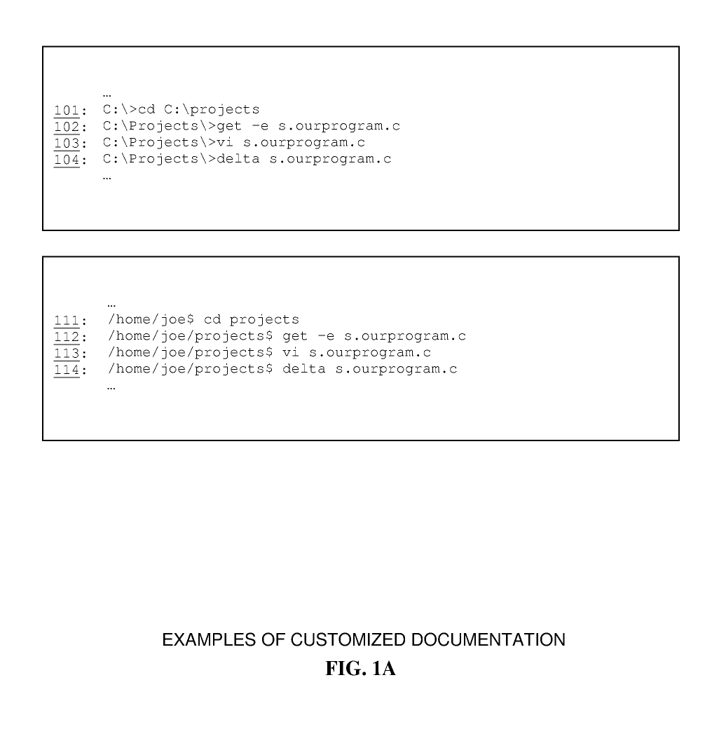

FIG. 1 illustrates a system 10 for customizing a documentation for a software product, in accordance with embodiments of the present invention.

The system 10 comprises a data storage 11, a documentation customizing process 20, and at least one custom value. The data storage 11 comprises a documentation template 13, at least one constraint, and a customized documentation 30.

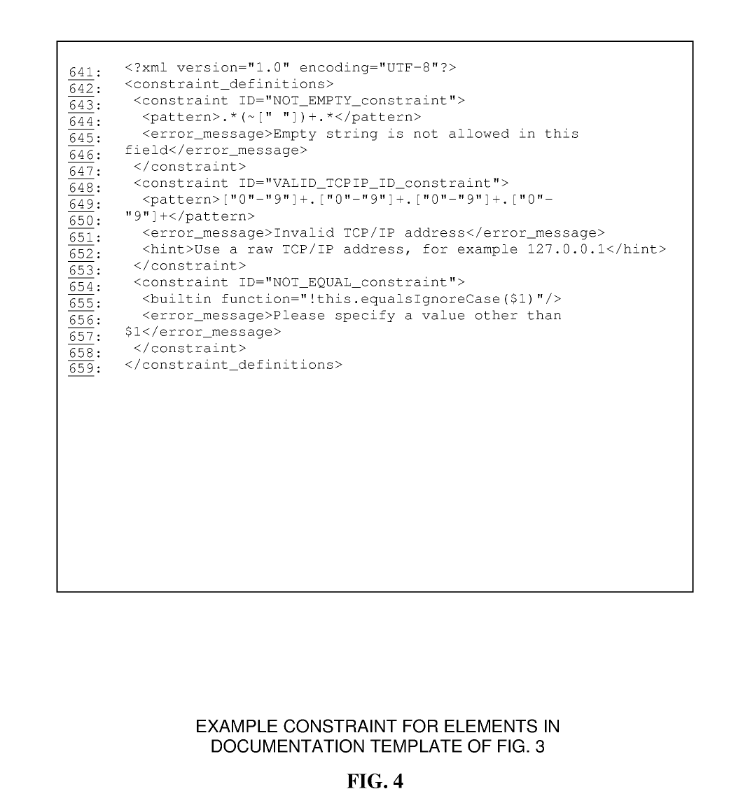

The documentation template 13 is a documentation describing information about a software product with at least one usage scenario. The documentation template 13 comprises at least one element that is customizable with a custom value 22 of said at least one custom value. In one embodiment of the present invention, the documentation template 13 is an Extensible Markup Language (XML) document. See FIG. 4, infra, for an example of the documentation template.

An element 14 of said at least one element is associated with said at least one constraint that governs how the element 14 should be customized. Each element of said at least one element is identified by a respective element identifier. The respective element identifier may be, inter alia, a unique string comprising a symbolic name, a mnemonic value, a common name, etc. The element 14 is initially displayed with a default value that is assigned for the element 14 such that the documentation template 13 can be used as a conventional documentation of the software product without being processed by the documentation customizing process 20. The element 14 may be customized by the documentation customizing process 20 with the custom value 22 that corresponds to the element 14 pursuant to the constraint 15.

In one embodiment of the present invention, the element 14 is derived from a system environment variable. The element 14 that is derived from the system environment variable can be automatically customized using the context of execution in which the user operates the documentation customizing system 10. Examples of the system environment variable may be, inter alia, a user identifier system variable, an operating system id, etc. In this embodiment, a user may override the automatically customized element with a custom value specified by the user. With this embodiment, when the documentation refers to commands and/or system variables based on the hardware and/or software platform the software is running on, the method of the present invention automatically customize the documentation with user environment that the software product operates on.

FIG. 1A illustrates examples of the customized documentation 30, in accordance with the embodiments of the present invention.

Lines 101 to 104 are a portion of the customized documentation describing a series of commands to be performed in Windows system environment. Lines 111 to 114 are a portion of the customized documentation describing a series of commands to be performed in AIX system environment. Wherein an element to be customized is $USERID with a value of “joe”, path information is customized pursuant to respective system environment.

In another embodiment of the present invention, the element 14 may be a section of the documentation template. In this embodiment, the documentation customizing system stores a usage history of the documentation by an individual user and then automatically adds and/or removes a section of the documentation based on the skill level of the individual user. This embodiment reduces overheads of providing entire online documentation for complex software product suites. The individual user may choose not to store the usage history and/or choose to view entire documentation regardless of the skill level stored in the usage history.

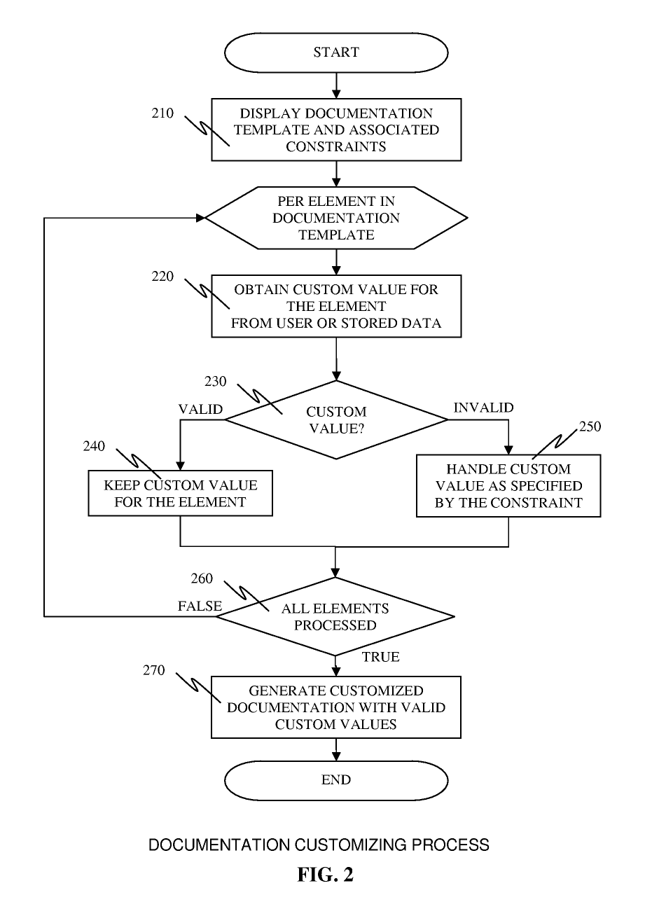

The documentation customizing process 20 takes the documentation template 13, the constraint 15, and the custom value 22 as inputs and generates the customized documentation 30 comprising the custom value 22 in place of the element 14 as a result. The documentation customizing process 20 receives the custom value 22 that is acceptable for the element 14 pursuant to the constraint 15. The custom value 22 may be any unique string that satisfies the constraint 15. See description of FIG. 2, infra, for details.

The constraint 15 associated with the element 14 defines a rule to be applied for the custom value 22 to be valid for the element 14 in customizing the documentation template 13. The constraint 15 may further comprise an error message that is presented if the user inputs an invalid custom value for an element. The constraint 15 also may further comprise a hint and/or a recommendation that guides a user to provide desirable custom values for optimal customization, which is displayed with an input dialog for the custom value. The hint in the constraint may suggest, inter alia, the user to input a system environment value specific to the user and proper string for the system environment variable. The constraint 15 specify, inter alia, a format of a valid custom value for the element, syntax and semantics of a valid custom value for the element, a range of acceptable custom values, a well-formedness, primarily tag matching and proper keywords in the tags, of the customized documentation in Extensible Markup Language (XML) format that is generated by the documentation customizing process, etc. The constraint 15 is used to check whether the custom value 22 is valid for the element 14 in maintaining syntactical and semantical integrity of the customized documentation 30. The constrain 15 is also used to increase readability of the customized documentation 30 by requiring distinctive names according to contexts of scenarios in the documentation templates.

At least one element of said at least one element is associated with at least one constraint. To determine whether a custom value provided for an element is valid, each constraint for the element is looked into. When the custom value does not satisfy the constraints associated with the element that the custom value is provided for, the custom value is rejected. By using the constraint 15, the user of the present invention can avoid inappropriate customization and the customized documentation 30 is in proper format and effectively customized as a result.

A constraint may as well be specified for more than one customizable element, for example, “the user-defined value for customizable element e1 and e2 must not be equal.” The documentation customizing system may predefine constraints as a list of constraints for at least one element.

A constraint is in a form of, inter alia, a regular expression against which a custom value provided by a user must match, a set of acceptable values, an executable code that processes and/or checks a custom value as valid, etc. The executable code comprises an input dialog, a custom value input field, and a display of an error message if the custom value does not satisfy the constraint that is associated with the element for which the custom value is provided. Such executable code may be implemented as, inter alia, a Java script operating in a web browser. A constraint as a set of acceptable values may be implemented as, inter alia, a tabular format such as a spreadsheet. Such tabular format constraint specifies valid value pattern in a regular expression form for custom values that is acceptable for the element that the constraint is associated with. The tabular format constraint may further comprise an appropriate auxiliary program that interprets the constraints and verifies whether a custom value satisfies that constraint, and further present an error messages if the custom value violates the constraint.

In one embodiment of the present invention, the author of the documentation can choose constraints from a predefined set of constraints.

In one embodiment of the present invention, a set of constraints is provided as an Extensible Markup Language (XML) document. See FIG. 4, infra, for an example of the constraint document.

In one embodiment of the present invention, the constraints may be, inter alia, a “non-empty” constraint with an error message stating “non-empty string value required”, a “no-white-space” constraint with an error message stating “for this field, please choose a value without white spaces inside”, a “integer-value” constraint with an error message stating “for this field, please choose a numeric value”, a “Java-identifier” constraint with an error message stating “for this field, please use a valid java identifier”, etc. See FIG. 4, infra, for an example of constraints defined in Extensible Markup Language (XML) document format.

Examples of error messages for constraints may be, inter alia, “the user-defined value for this customizable element may not be the empty string”, “the user-defined value for this customizable element may not contain a blank”, “the user-defined value for this customizable element may not be longer than 16 chars”, “the user-defined value for this customizable element must be numeric”, “the user-defined value for this customizable element must be mixed case”, “the user-defined value for this customizable element must be taken from character set [_ABCDEFGHIJKLMNOPQRSTUVWXYZ]”, “the user-defined value for this customizable element may not contain a reserved XML syntax element, e.g. ‘<’ or ‘>’”, “the user-defined value for customizable element e1 and e2 must not be equal”, “the user-defined value for this customizable element must be a valid first name as defined in this reference list: . . . ”, “the user-defined value for this customizable element must be a female first name”, “the user-defined value for this customizable element must be a city name as defined in this reference list: . . . ”, “the user-defined value for this customizable element may not be a word occurring in the following list: . . . ”, “the user-defined value for this customizable element may not be a word already occurring in the text (i.e. the version of the text before customization)”.

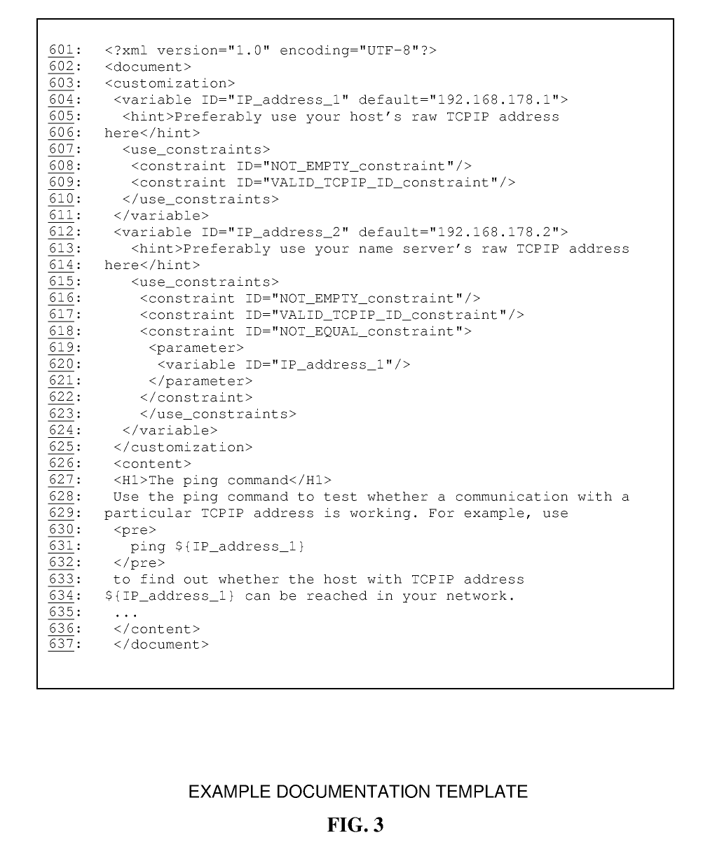

In one embodiment of the present invention, the documentation template 13 and a set of constraints comprising the constraint 14 are in Hypertext Markup Language (HTML) document format that employs a web browser for user interface. See FIGS. 3 and 4, infra, for examples. Constraints in executable code format may be implemented in JavaScript that is executed in the web browser environment.

FIG. 2 is a flowchart depicting a method for customizing a documentation with at least one constraint-controlled custom value, in accordance with the embodiments of the present invention.

In step 210, the documentation customizing process displays a documentation template and constraints that are associated with elements in the documentation template, to inform a user how to provide custom values for the elements in the documentation template. If default values are specified for each element, the documentation customizing process displays the documentation template with respective default values in place of each elements such that the documentation template can be used as a complete documentation without customization as in conventional documentation provision.

Either steps 220, 230, 240, 260 or steps 220, 230, 250, 260, depending on the validity of a custom value, are performed for each element in the documentation template that requires a respective custom value.

In step 220, the documentation customizing process obtains the custom value for an element in the documentation template.

In one embodiment of the present invention, the documentation customizing process may use an input dialog for an interactive input from a user, wherein the input dialog comprises information guiding the user to provide a custom value satisfying a constraint associated with the element and an entry field of the custom value. Information provided in the input dialog may be, inter alia, a help text, the constraint, an exemplary valid value, etc.

In another embodiment of the present invention, the documentation customizing process may receive the custom value from a data file set by a system administrator and/or system variables without an interactive user input.

In step 230, the documentation customizing process checks the validity of the custom value obtained in step 220 against all constraints associated with the element for which the custom value is provided. The format of the constraint determines how the validity of the custom value is determined. If the constraint is an executable code, then the executable code is executed against the custom value as a parameter to check validity of the custom value. If the constraint is a table of acceptable values, then the documentation customizing process checks if the custom value is in the table.

If the documentation customizing process determines that the custom value satisfies the constraint associated with the element, the documentation customizing process proceeds with step 240. If the documentation customizing process determines that the custom value does not satisfy the constraint associated with the element, the documentation customizing process proceeds with step 250.

In one embodiment, the validity of the custom value may be determined based on the significance of the constraint that the custom value must meet. In this embodiment, constraints are classified according to the impact of the constraint to the customized documentation. Some constraints may not be explicitly specified, and the custom values violating such implied constraints can still be used as a valid custom value. Other constraints must be satisfied for the custom value to be used in the customized documentation. Examples of a critical constraint may be, inter alia, unbalanced html tags, unbalanced parentheses, unbalanced quotes, etc. that break a basic document structure of the customized documentation. Even when the custom values violating non-critical constraints, the method of the present invention may use a proofreading and/or correcting step to produce a more readable customized documentation. Examples for a custom values applicable for the proofreading/correcting step may be, inter alia, contextual and/or grammatical errors such as a gender/number/tense mismatch within a single document, etc. When the custom value is provided for the element describing a usage scenario with commands, syntax for the commands and associated parameters may be additionally checked to see whether the customized commands are executable.

In step 240, the documentation customizing process keeps the custom value for the element to use the custom value in step 270 because the custom value is determined to be valid.

In step 250, the documentation customizing process handles the custom value as specified by the constraint because the custom value is determined to be invalid. The constraint may reject the invalid custom value and prompt the user to provide a new value with an error message. The constraint also may accept the invalid value for customization and display a warning message.

In step 260, the documentation customizing process determines whether custom values for all elements in the documentation template are obtained. If the documentation customizing process determines that custom values for all elements in the documentation template are not obtained, then the documentation customizing process loops back to step 220 for the next element in the documentation template. If the documentation customizing process determines that custom values for all elements in the documentation template are obtained, then the documentation customizing process proceeds with step 270.

In step 270, the documentation customizing process generates a customized documentation by replacing each element with a respective custom value that is obtained for each element. The documentation customizing process then transmits the customized documentation to an output device of a computer system through which the user accesses the documentation customizing process. In rendering the customized documentation on the output device, the documentation customizing process may use distinctive fonts and/or colors that mark customized elements in the documentation template so that the user can easily distinguish and/or verify the custom values. In another embodiment of the present invention, the custom values may be dynamically substituted while rendering the document, as opposed to replacing all elements prior to rendering the customized documentation.

FIG. 3 illustrates an example of a documentation template, in accordance with the embodiments of the present invention.

The documentation template is written in Extensible Markup Language (XML). Lines 603 to 625 are a customization part and lines 626 to 636 are a content part.

The customization part describes customizable elements that are declared in the documentation template. Each element is presented between <variable> and </variable>. The first element in lines 604 to 611 is a customizable variable identified as “IP_address_{—}1”, comprising a default value of “192.168.178.1”. Constraints to check the validity of the first element are present in lines 607 to 610. The first element is associated with two constraints, the first constraint in line 608 that is identified as “NOT_EMPTY_constraint”, and the second constraint in line 609 that is identified as “VALID_TCPIP_ID_constraint”.

The second element in lines 612 to 624 is a customizable variable identified as “IP_address_{—}2”, comprising a default value of “192.168.178.2”. Constraints to check the validity of the first element are present in lines 615 to 622. The second element is associated with three constraints, the first constraint in line 616 that is identified as “NOT_EMPTY_constraint”, the second constraint in line 617 that is identified as “VALID_TCPIP_ID_constraint”, and the third constraint in lines 618 to 622 that is identified as “NOT_EQUAL_constraint” and that comprises a parameter shown in lines 619 to 621 which is the first element “IP_address_{—}1”.

FIG. 4 illustrates an example of a set of constraint definitions provided for the documentation template of FIG. 3, supra, in accordance with the embodiments of the present invention.

The first constraint with an identifier of “NOT_EMPTY_constraint” is defined in lines 633 to 637. Line 634 defines a regular expression pattern “.*(˜[“ ”])+.*” that an element controlled by the first constraint must meet. The regular expressions indicates that, to satisfy the first constraint, a custom value must match the pattern of at least one char unequal to “ ” (a blank/space) in a sequence of arbitrary characters.

The second constraint with an identifier of “VALID_TCPIP_ID_constraint” is defined in lines 638 to 643. Lines 639 and 640 define a regular expression pattern that an element controlled by the second constraint must meet.

The third constraint with an identifier of “NOT_EQUAL_constraint” is defined in lines 644 to 647. Line 645 defines a built-in function to check a custom value provided for the third constraint, which compares the custom value with a value provided as a parameter of the third constraint.

For each constraint, a respective error message is provided, which is displayed if an invalid custom value that violates the constraint is provided.

The second constraint definition “VALID_TCPIP_ID_constraint” is meant to enforce a 32 bit raw TCP/IP address consisting of 4 numbers each having at least one digit, and these 4 numbers are separated by 3 dot characters. In addition to the error message, this constraint contains a hint that can be displayed as help text to support the user in choosing the optimal custom value.

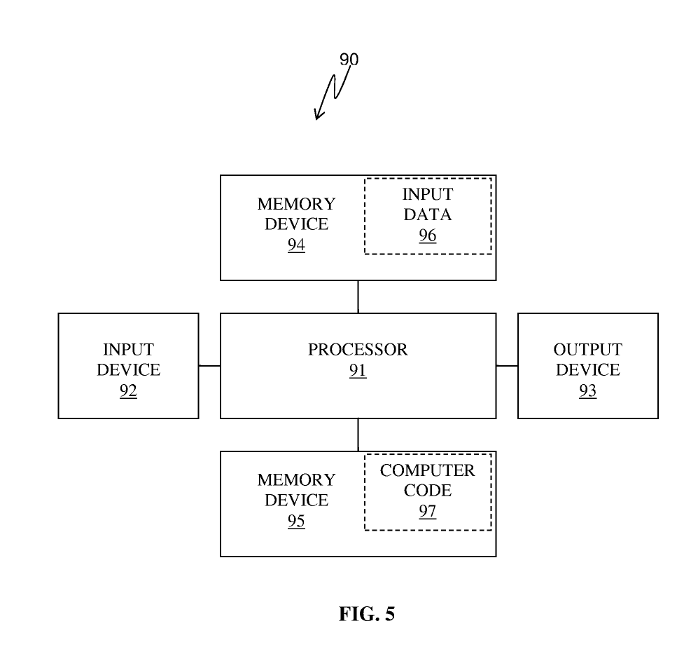

FIG. 5 illustrates a computer system 90 used for customizing a documentation with constraint-controlled custom values, in accordance with embodiments of the present invention.

The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, a keypad, a touchscreen, a voice recognition device, a sensor, a network interface card (NIC), a Voice/video over Internet Protocol (VoIP) adapter, a wireless adapter, a telephone adapter, a dedicated circuit adapter, etc. The output device 93 may be, inter alia, a printer, a plotter, a computer screen, a magnetic tape, a removable hard disk, a floppy disk, a NIC, a VoIP adapter, a wireless adapter, a telephone adapter, a dedicated circuit adapter, an audio and/or visual signal generator, a light emitting diode (LED), etc. The memory devices 94 and 95 may be, inter alia, a cache, a dynamic random access memory (DRAM), a read-only memory (ROM), a hard disk, a floppy disk, a magnetic tape, an optical storage such as a compact disk (CD) or a digital video disk (DVD), etc. The memory device 95 includes a computer code 97 which is a computer program that comprises computer-executable instructions. The computer code 97 includes, inter alia, an algorithm used for customizing documentation with constraint-controlled custom values according to the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may be used as a computer usable storage medium (or a computer readable storage medium or a program storage device) having a computer readable program embodied therein and/or having other data stored therein, wherein the computer readable program comprises the computer code 97. Generally, a computer program product (or, alternatively, an article of manufacture) of the computer system 90 may comprise said computer usable storage medium (or said program storage device).

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for customizing a documentation, the method comprising:
presenting a documentation template comprising at least one element, wherein each element of said at least one element can hold a respective value, wherein at least one element of said at least one element is associated with at least one constraint that governs the respective value of each element;
obtaining the respective value of each element, wherein said respective value is customized for a user of the documentation to provide a preferred context of the documentation to the user;
determining that the respective value of each element satisfies all constraints of said at least one constraint that is associated with each element; and
generating a customized documentation by instantiating said at least one element in the documentation template with said respective value for each element of said at least one element.

2. The method of claim 1, said presenting comprising:
displaying the documentation template on a screen of a computer system of the user, wherein said documentation template further comprises a respective hint message associated with each element, wherein the respective hint message guides the user to provide the respective value that satisfies all constraints of said at least one constraint that is associated with each element.

3. The method of claim 1, said obtaining comprising:
receiving, interactively, a value of an element of said at least one element from the user through an input dialog comprising an entry field for the element.

4. The method of claim 1, said obtaining comprising:
retrieving, automatically, a value of an element of said at least one element from a corresponding system variable, wherein said obtaining is performed in a system environment comprising said corresponding system variable.

5. The method of claim 1, said determining comprising:
determining that a value for an element of said at least one element does not satisfy a constraint associated with the element; and
discovering that the constraint associated with the element for which the value is provided is a non-critical constraint, wherein the customized documentation generated with the value that does not satisfy the non-critical constraint is syntactically sound.

6. The method of claim 1, said generating comprising:
storing the customized documentation for the user in a storage medium such that the customized documentation can be retrieved for a later use; and
displaying the customized documentation on a screen of a computer system of the user.

7. The method of the claim 1, wherein the author of said documentation template is provided with a set of predefined constraints, where each of the predefined constraints can be enabled to govern the respective value for said at least one element.

8. A computer program product, comprising a computer usable storage medium having a computer readable program code embodied therein, said computer readable program code containing instructions that when executed by a processor of a computer system implement a method for customizing a documentation, the method comprising:
presenting a documentation template comprising at least one element, wherein each element of said at least one element can hold a respective value, wherein at least one element of said at least one element is associated with at least one constraint that governs the respective value of each element;
obtaining the respective value of each element, wherein said respective value is customized for a user of the documentation to provide a preferred context of the documentation to the user;
determining that the respective value of each element satisfies all constraints of said at least one constraint that is associated with each element; and
generating a customized documentation by instantiating said at least one element in the documentation template with said respective value for each element of said at least one element.

9. The computer program product of claim 8, said presenting comprising:
displaying the documentation template on a screen of a computer system of the user, wherein said documentation template further comprises a respective hint message associated with each element, wherein the respective hint message guides the user to provide the respective value that satisfies all constraints of said at least one constraint that is associated with each element.

10. The computer program product of claim 8, said obtaining comprising:
receiving, interactively, a value of an element of said at least one element from the user through an input dialog comprising an entry field for the element.

11. The computer program product of claim 8, said obtaining comprising:
retrieving, automatically, a value of an element of said at least one element from a corresponding system variable, wherein said obtaining is performed in a system environment comprising said corresponding system variable.

12. The computer program product of claim 8, said determining comprising:
determining that a value for an element of said at least one element does not satisfy a constraint associated with the element; and
discovering that the constraint associated with the element for which the value is provided is a non-critical constraint, wherein the customized documentation generated with the value that does not satisfy the non-critical constraint is syntactically sound.

13. The computer program product of claim 8, said generating comprising:
storing the customized documentation for the user in a storage medium such that the customized documentation can be retrieved for a later use; and
displaying the customized documentation on a screen of a computer system of the user.

14. The computer program product of claim 8, wherein the author of said documentation template is provided with a set of predefined constraints, where each of the predefined constraints can be enabled to govern the respective value for said at least one element.

15. A computer system comprising a processor and a computer readable memory unit coupled to the processor, said memory unit containing instructions that when executed by the processor implement a method for customizing a documentation, the method comprising:
presenting a documentation template comprising at least one element, wherein each element of said at least one element can hold a respective value, wherein at least one element of said at least one element is associated with at least one constraint that governs the respective value of each element;
obtaining the respective value of each element, wherein said respective value is customized for a user of the documentation to provide a preferred context of the documentation to the user;
determining that the respective value of each element satisfies all constraints of said at least one constraint that is associated with each element; and
generating a customized documentation by instantiating said at least one element in the documentation template with said respective value for each element of said at least one element,
wherein said documentation template and said at least one constraint are written in Extensible Markup Language (XML), and wherein said at least one element can be cross-referenced among elements.

16. The computer system of claim 15, said presenting comprising:
displaying the documentation template on a screen of a computer system of the user, wherein said documentation template further comprises a respective hint message associated with each element, wherein the respective hint message guides the user to provide the respective value that satisfies all constraints of said at least one constraint that is associated with each element.

17. The computer system of claim 15, said obtaining comprising:
receiving, interactively, a value of an element of said at least one element from the user through an input dialog comprising an entry field for the element.

18. The computer system of claim 15, said obtaining comprising:
retrieving, automatically, a value of an element of said at least one element from a corresponding system variable, wherein said obtaining is performed in a system environment comprising said corresponding system variable.

19. The computer system of claim 15, said determining comprising:
determining that a value for an element of said at least one element does not satisfy a constraint associated with the element; and
discovering that the constraint associated with the element for which the value is provided is a non-critical constraint, wherein the customized documentation generated with the value that does not satisfy the non-critical constraint is syntactically sound.

20. The computer system of claim 15, said generating comprising:
storing the customized documentation for the user in a storage medium such that the customized documentation can be retrieved for a later use; and
displaying the customized documentation on a screen of a computer system of the user.
